(19) United States
(12) Patent Application Publication
(10) Pub. No.: US 2026/0092882 A1
(43) Pub. Date: Apr. 2, 2026

(54) X-RAY IMAGING APPARATUS AND X-RAY TUBE

(71) Applicant: SHIMADZU CORPORATION, Kyoto-shi (JP)

(72) Inventors: Naoki MORIMOTO, Kyoto-shi (JP); Tetsuya KOBAYASHI, Kyoto-shi (JP)

(21) Appl. No.: 19/328,925

(22) Filed: Sep. 15, 2025

(30) Foreign Application Priority Data
Oct. 2, 2024 (JP) 2024-173881

(51) Int. Cl. G01N 23/046

(52) U.S. Cl. CPC G01N 23/046; G01N 2223/1016; G01N 2223/102; G01N 2223/204; G01N 2223/306; G01N 2223/309; G01N 2223/3306; G01N 2223/419

(57) ABSTRACT

An X-ray imaging apparatus 100 comprises an X-ray tube 1 including a first electron irradiation unit 10a and a second electron irradiation unit 10b, a detector 2, a subject placement unit 3, a rotation mechanism 4, and a control unit 21, wherein the control unit 21 performs a control to cause electrons to be irradiated simultaneously from the first electron irradiation unit 10a and the second electron irradiation unit 10b for each of a plurality of imaging angles 6, and a control to make a first relative focal position 7a of the first electron irradiation unit 10a at a first imaging angle 6a, a second relative focal position 7b of the second electron irradiation unit 10b at the first imaging angle 6a, a third relative focal position 7d of the first electron irradiation unit 10a at a second imaging angle 6b, and a fourth relative focal position 7e of the second electron irradiation unit 10b at the second imaging angle 6b different from each other so as not to overlap.

### TECHNICAL FIELD

The present invention relates to an X-ray imaging apparatus and an X-ray tube.

### BACKGROUND ART

Conventionally, X-ray imaging apparatuses are known (see, for example, Patent Literature 1).

The aforementioned Patent Literature 1 discloses an X-ray CT imaging apparatus (X-ray imaging apparatus) that performs CT (Computed Tomography) imaging of a subject. The X-ray CT imaging apparatus includes an X-ray tube, a detector, a subject placement unit on which the subject is placed, and a computer (control unit). The X-ray tube irradiates X-rays toward the subject, which rotates together with the subject placement unit. The detector detects the X-rays irradiated from the X-ray tube. The computer generates a CT image based on a plurality of projection image data acquired by the detector. The X-ray tube includes a single cathode element (electron irradiation unit) and a target. By irradiating electrons from the cathode element toward a focal position on the target, X-rays are emitted from the focus (focal position) on the target toward the detector.

### CITATION LIST

### Patent Literature

[Patent Literature 1] U.S. Pat. No. 9,153,408

### SUMMARY OF INVENTION

### Technical Problem

Although not disclosed in the aforementioned Patent Literature 1, in an X-ray CT imaging apparatus (X-ray imaging apparatus), when generating a CT image, a plurality of projection image data are acquired by imaging the subject from various imaging angles. To generate a high-definition CT image, projection image data from a sufficient number of imaging angles (number of views) is required, but the imaging time taken to acquire projection image data from a sufficient number of imaging angles increases. If the number of imaging angles remains small without increasing the imaging time for acquiring projection image data, artifacts due to the small number of imaging angles (few views) occur in the reconstructed image (CT image). Therefore, it is desired to reduce artifacts caused by a small number of imaging angles while suppressing an increase in the imaging time required for acquiring projection image data.

The present invention has been made to solve the above-described problem, and an object of the present invention is to provide an X-ray imaging apparatus and an X-ray tube capable of reducing artifacts caused by a small number of imaging angles while suppressing an increase in the imaging time required for acquiring projection image data.

### Solution to Problem

An X-ray imaging apparatus comprising: an X-ray tube including at least a first electron irradiation unit and a second electron irradiation unit for irradiating electrons to different focal positions on a target; a detector for detecting X-rays emitted from the X-ray tube; a subject placement unit arranged between the X-ray tube and the detector, for placing a subject thereon; a rotation mechanism for rotating one of an imaging unit including the X-ray tube and the detector, and the subject placement unit, so as to change an imaging angle of the subject; and a control unit for acquiring a plurality of projection image data at each of a plurality of imaging angles from the detector, and for generating a CT image based on the acquired plurality of projection image data, wherein the control unit performs: a control to cause electrons to be irradiated simultaneously from the first electron irradiation unit and the second electron irradiation unit for each of the plurality of imaging angles; and a control to make a first relative focal position of the first electron irradiation unit with respect to the subject at a first imaging angle, a second relative focal position of the second electron irradiation unit with respect to the subject at the first imaging angle, a third relative focal position of the first electron irradiation unit with respect to the subject at a second imaging angle, and a fourth relative focal position of the second electron irradiation unit with respect to the subject at the second imaging angle different from each other so as not to overlap.

Furthermore, an X-ray tube used in an X-ray imaging apparatus that acquires a plurality of projection image data at a plurality of imaging angles and generates a CT image based on the acquired plurality of projection image data, the X-ray tube comprising: at least a first electron irradiation unit and a second electron irradiation unit for simultaneously irradiating electrons to different focal positions of a target, wherein an inter-focal distance between a first focus of the first electron irradiation unit and a second focus of the second electron irradiation unit, and a number of foci on the target are preset such that a first relative focal position of the first electron irradiation unit with respect to the subject at a first imaging angle, a second relative focal position of the second electron irradiation unit with respect to the subject at the first imaging angle, a third relative focal position of the first electron irradiation unit with respect to the subject at a second imaging angle, and a fourth relative focal position of the second electron irradiation unit with respect to the subject at the second imaging angle are different from each other without overlapping.

### Advantageous Effects of Invention

In the aforementioned X-ray imaging apparatus, by simultaneously irradiating electrons from a plurality of electron irradiation units including the first electron irradiation unit and the second electron irradiation unit to different focal positions on the target for each of the plurality of imaging angles, a plurality of projection image data corresponding to the number of the plurality of electron irradiation units can be acquired for each imaging angle. Therefore, the number of acquired projection image data can be increased without increasing the imaging time. Furthermore, by making the first to fourth relative focal positions different from each other so as not to overlap, the imaging angles of the subject in the plurality of projection image data acquired for each imaging angle, corresponding to the number of the plurality of electron irradiation units, can be made different from each other. Thus, projection image data at different imaging angles can be acquired for each of the acquired plurality of projection image data. Therefore, projection image data for a sufficient number of imaging angles (number of views) can be acquired from the increased projection image data. For these reasons, it is possible to reduce artifacts caused by a small number of imaging angles while suppressing an increase in the imaging time required for acquiring projection image data. Here, in the present specification, the relative focal position means the relative position with respect to the subject of a focus formed on the target in the X-ray tube that rotates relatively around the subject. The relative focal position of each of the first electron irradiation unit and the second electron irradiation unit with respect to the subject changes due to the rotation of the subject placement unit or the X-ray tube by the rotation mechanism.

Furthermore, in the aforementioned X-ray tube, by simultaneously irradiating electrons from a plurality of electron irradiation units including the first electron irradiation unit and the second electron irradiation unit to different focal positions on the target for each of the plurality of imaging angles, a plurality of projection image data corresponding to the number of the plurality of electron irradiation units can be acquired for each imaging angle. Therefore, the number of acquired projection image data can be increased without increasing the imaging time. Furthermore, because the inter-focal distance between the first focus of the first electron irradiation unit and the second focus of the second electron irradiation unit, and the number of foci on the target are preset such that the first to fourth relative focal positions are different from each other without overlapping, projection image data at different imaging angles can be acquired for each of the acquired plurality of projection image data. Therefore, projection image data for a sufficient number of imaging angles (number of views) can be acquired from the increased projection image data. For these reasons, it is possible to reduce artifacts caused by a small number of imaging angles while suppressing an increase in the imaging time required for acquiring projection image data.

### BRIEF DESCRIPTION OF DRAWINGS

FIG. 1 is a schematic diagram illustrating the overall configuration of an X-ray imaging apparatus according to an embodiment.

FIG. 2 is a diagram for explaining a configuration for simultaneously irradiating electrons from a plurality of electron irradiation units.

FIG. 3 is a schematic diagram for explaining the configuration of a plurality of electron emitting units.

FIGS. 4A, 4B and 4C are diagrams for explaining the positional relationship of relative focal positions in an embodiment.

FIGS. 5A, 5B and 5C are diagrams for explaining the positional relationship of relative focal positions in a first comparative example.

FIGS. 6A, 6B, 6C and 6D are diagrams for explaining the number of relative focal positions and the positional relationship of the relative focal positions in an embodiment.

FIG. 7 is a diagram for explaining the number of relative focal positions and the positional relationship of the relative focal positions in a second comparative example.

FIG. 8 is a flowchart for explaining X-ray image capturing processing and reconstruction processing.

FIGS. 9A, 9B and 9C are diagrams for explaining a comparison result between tomographic images acquired by X-ray imaging apparatuses in a third comparative example and a fourth comparative example, and a tomographic image acquired by the X-ray imaging apparatus in an embodiment.

FIGS. 10A, 10B, and 10C are partial enlarged views and FIG. 10D is a graph for explaining a comparison result between tomographic images acquired by X-ray imaging apparatuses in the third comparative example and the fourth comparative example, and a tomographic image acquired by the X-ray imaging apparatus in an embodiment.

### DESCRIPTION OF EMBODIMENTS

Hereinafter, an embodiment embodying the present invention will be described based on the drawings.

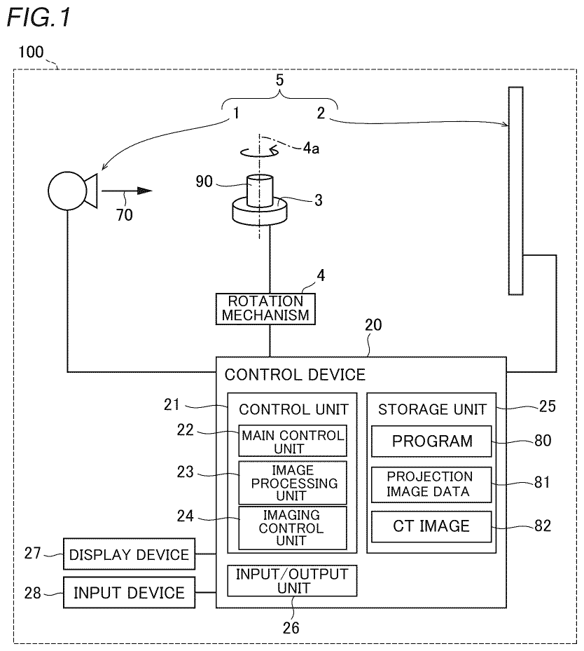

First, the overall configuration of an X-ray imaging apparatus 100 according to an embodiment will be described with reference to FIGS. 1 to 3.

As shown in FIG. 1, the X-ray imaging apparatus 100 is an apparatus that captures an X-ray image of a subject 90 and generates a CT image 82. The X-ray imaging apparatus 100 of the present embodiment is used, for example, for non-destructive inspection purposes. The subject 90 to be inspected is not particularly limited as long as it is an object other than a living body. The X-ray imaging apparatus 100 acquires projection image data 81 (X-ray image data) of the subject 90 from the entire circumference of the subject 90 placed on the subject placement unit 3, and constructs a tomographic image based on the acquired projection image data 81.

The X-ray imaging apparatus 100 includes an X-ray tube 1, a detector 2, a subject placement unit 3, a rotation mechanism 4, and a control device 20. The X-ray tube 1 and the detector 2 constitute an imaging unit 5 that captures an X-ray image.

The X-ray tube 1 is configured to irradiate X-rays 70 to the subject 90 placed on the subject placement unit 3. The X-ray tube 1 is configured to generate X-rays 70 when a high voltage is applied. The X-ray tube 1 faces the detector 2 via the subject placement unit 3. The X-ray tube 1, the subject placement unit 3, and the detector 2 are arranged side by side in the horizontal direction. In the present embodiment, the X-ray tube 1 is configured as a micro-focus X-ray tube with a focal spot size in the micron unit. Note that the X-ray tube 1 may be configured as an X-ray tube with a focal spot size in the millimeter unit.

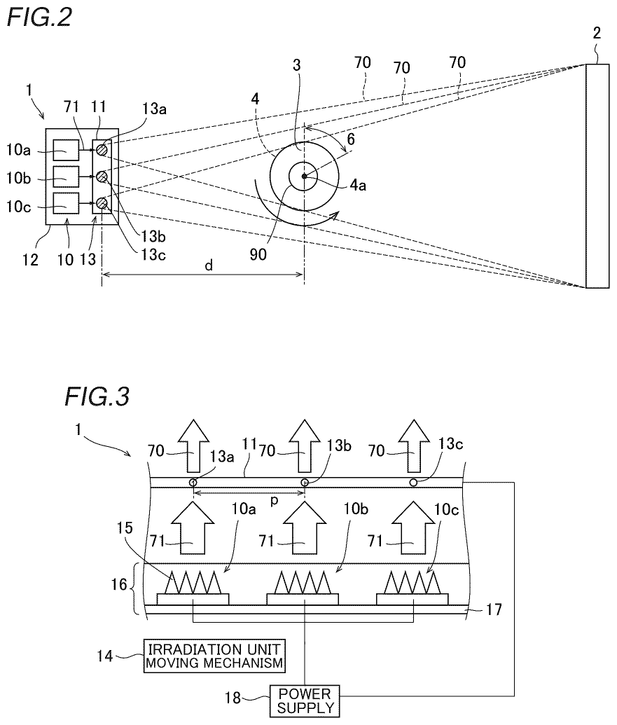

As shown in FIG. 2, the X-ray tube 1 includes a plurality of electron irradiation units 10. Each of the plurality of electron irradiation units 10 simultaneously irradiates electrons 71 to different focal positions 13 on a target 11. In the present embodiment, the X-ray tube 1 includes a first electron irradiation unit 10a, a second electron irradiation unit 10b, and a third electron irradiation unit 10c. Each of the first electron irradiation unit 10a, the second electron irradiation unit 10b, and the third electron irradiation unit 10c simultaneously irradiates electrons 71 to different focal positions 13 on the target 11. The detailed configuration of the X-ray tube 1 will be described later.

The detector 2 is configured to detect the X-rays 70 emitted from the X-ray tube 1. The X-rays 70 emitted from the X-ray tube 1 pass through the subject 90 and are incident on the detection surface of the detector 2. The detector 2 is configured to convert the detected X-rays 70 into electrical signals. Thereby, an X-ray image reflecting the transmission of the X-rays 70 through the subject 90 is obtained. The detector 2 is, for example, an FPD (Flat Panel Detector). The detector 2 is composed of a plurality of conversion elements (not shown) and a plurality of pixel electrodes (not shown) arranged on the plurality of conversion elements. The plurality of conversion elements and pixel electrodes are arranged in a matrix in the detection plane at a predetermined period (pixel pitch).

The detector 2 is configured to simultaneously detect the X-rays 70 based on the electrons 71 irradiated by the first electron irradiation unit 10a, the X-rays 70 based on the electrons 71 irradiated by the second electron irradiation unit 10b, and the X-rays 70 based on the electrons 71 irradiated by the third electron irradiation unit 10c. The detector 2 converts the X-rays 70 based on the first electron irradiation unit 10a, the X-rays 70 based on the second electron irradiation unit 10b, and the X-rays 70 based on the third electron irradiation unit 10c into electrical signals. A detection signal (image signal) including a first detection signal (first image signal) of the X-rays 70 based on the first electron irradiation unit 10a, a second detection signal (second image signal) of the X-rays 70 based on the second electron irradiation unit 10b, and a third detection signal (third image signal) of the X-rays 70 based on the third electron irradiation unit 10c is sent to an image processing unit 23, which will be described later.

The subject placement unit 3 is arranged between the X-ray tube 1 and the detector 2 and is configured to place the subject 90 thereon. The subject placement unit 3 is configured by a subject stage on which the subject 90 is placed.

The rotation mechanism 4 rotates one of the imaging unit 5 including the X-ray tube 1 and the detector 2, and the subject placement unit 3. Thereby, the rotation mechanism 4 is configured to change the imaging angle 6 (see FIG. 2) of the subject 90. The rotation mechanism 4 rotates one of the imaging unit 5 and the subject placement unit 3 around a rotation axis 4a. The rotation axis 4a is orthogonal to a straight line (a representative line of the X-ray flux) extending from the X-ray tube 1, through the subject 90 on the subject placement unit 3, to the detector 2. In the present embodiment, the rotation axis 4a passes through the subject placement unit 3 and is aligned in the vertical direction.

In the present embodiment, the rotation mechanism 4 rotates the subject placement unit 3 around the rotation axis 4a in a horizontal plane. The rotation mechanism 4 does not rotate the imaging unit 5. The rotation mechanism 4 includes a motor (not shown) and a reducer (not shown) for rotating the subject placement unit 3.

With the rotation of the subject placement unit 3, the subject 90 placed on the subject placement unit 3 is rotated around the rotation axis 4a in the horizontal plane. The rotation changes the imaging angle 6 (see FIG. 2) of the subject 90. The imaging angle 6 is the relative angle between the subject 90 and the imaging unit 5. In the present embodiment, the imaging angle 6 is the angle of the subject placement unit 3 around the rotation axis 4a, with the origin angle (initial angle) of the rotation mechanism 4 being 0 degrees. FIG. 2 shows an example of a state where the subject placement unit 3 is rotated from the origin angle to a certain imaging angle 6. The rotation mechanism 4 can rotate the subject placement unit 3 to an arbitrary angle so as to position the subject 90 at an arbitrary imaging angle 6.

As shown in FIG. 1, the control device 20 includes a control unit 21, a storage unit 25, and an input/output unit 26. The control device 20 is configured, for example, by a PC (Personal Computer). The control device 20 is connected to a display device 27 and an input device 28.

The control unit 21 is a computer including a CPU (Central Processing Unit), a GPU (Graphics Processing Unit), a ROM (Read Only Memory), and a RAM (Random Access Memory), etc. The control unit 21 performs predetermined control by the CPU executing a predetermined program 80. The control unit 21 includes, as functional configurations, a main control unit 22, an image processing unit 23, and an imaging control unit 24. That is, the control unit 21 functions as the main control unit 22, the image processing unit 23, and the imaging control unit 24 by the CPU executing the predetermined program 80. Note that the image processing unit 23 and the imaging control unit 24 are an example of the “control unit” in the claims.

The main control unit 22 sets imaging conditions in the X-ray imaging apparatus 100 and controls the start and stop of imaging by executing the program 80 stored in the storage unit 25.

The image processing unit 23 acquires a plurality of projection image data 81 at each of a plurality of imaging angles 6 from the detector 2. In the present embodiment, at each imaging angle 6, the image processing unit 23 acquires from the detector 2 a first detection signal, which is the electrical signal converted from the X-rays 70 based on the first electron irradiation unit 10a, a second detection signal, which is the electrical signal converted from the X-rays 70 based on the second electron irradiation unit 10b, and a third detection signal, which is the electrical signal converted from the X-rays 70 based on the third electron irradiation unit 10c. The image processing unit 23 generates projection image data 81 from the acquired first detection signal, generates projection image data 81 from the acquired second detection signal, and generates projection image data 81 from the acquired third detection signal. That is, for each imaging angle 6, the image processing unit 23 generates projection image data 81 from each of the first to third detection signals from the detector 2. As described above, by changing the imaging angle 6 of the subject 90 with the rotation mechanism 4, an X-ray image of the subject 90 is captured by the imaging unit 5 including the first to third electron irradiation units 10c at each of a plurality of preset imaging angles 6. The projection image data 81 is data of an X-ray image based on each of the first to third detection signals acquired for each imaging angle 6.

The acquisition of the projection image data 81 based on each of the first to third detection signals for each imaging angle 6 is performed over a preset predetermined angular range. The preset predetermined angular range is 360 degrees (one rotation). Note that the preset predetermined angular range is not limited to 360 degrees (one rotation) and is not particularly limited as long as it is 180 degrees (half rotation) or more. The plurality of imaging angles 6 are respective angles set at equal angular intervals obtained by dividing the predetermined angular range (360 degrees (one rotation)) by the number of imaging angles.

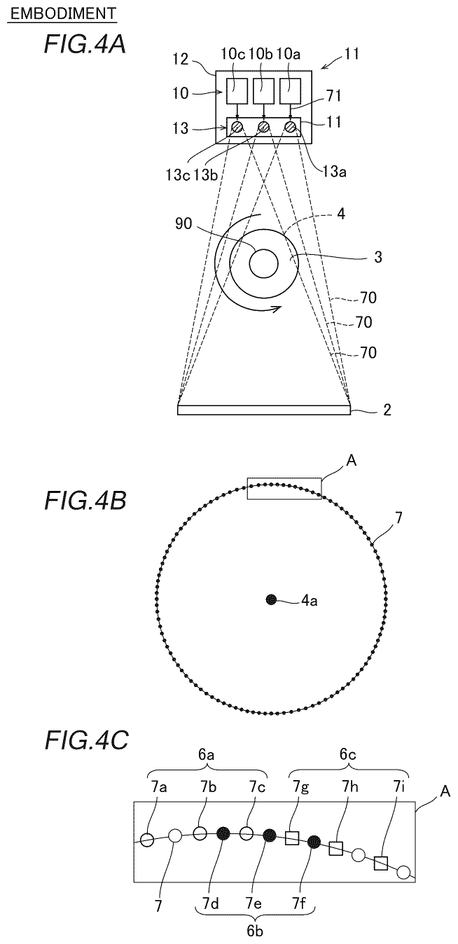

Here, as shown in FIG. 4C, a first relative focal position 7a of the first electron irradiation unit 10a with respect to the subject 90 at a first imaging angle 6a, a second relative focal position 7b of the second electron irradiation unit 10b with respect to the subject 90 at the first imaging angle 6a, a third relative focal position 7c of the third electron irradiation unit 10c with respect to the subject 90 at the first imaging angle 6a, a fourth relative focal position 7d of the first electron irradiation unit 10a with respect to the subject 90 at a second imaging angle 6b, a fifth relative focal position 7e of the second electron irradiation unit 10b with respect to the subject 90 at the second imaging angle 6b, and a sixth relative focal position 7f of the third electron irradiation unit 10c with respect to the subject 90 at the second imaging angle 6b, are different from each other so as not to overlap.

That is, the imaging angles 6 of the subject 90 in the projection image data 81 based on each of the first to third detection signals at the first imaging angle 6a are different from each other, the imaging angles 6 of the subject 90 in the projection image data 81 based on each of the first to third detection signals at the second imaging angle 6b are different from each other, and all of the imaging angles 6 of the subject 90 in the projection image data 81 based on each of the first to third detection signals at the first imaging angle 6a and the imaging angles 6 of the subject 90 in the projection image data 81 based on each of the first to third detection signals at the second imaging angle 6b are different from each other.

Note that the numbers attached to the relative focal positions 7 are numbers sequentially assigned according to the number of electron irradiation units 10 for convenience of explanation. Therefore, the fourth relative focal position 7d in the present embodiment is an example of the “third relative focal position of the first electron irradiation unit with respect to the subject at a second imaging angle” in the claims, and the fifth relative focal position 7e in the present embodiment is an example of the “fourth relative focal position of the second electron irradiation unit with respect to the subject at the second imaging angle” in the claims.

As shown in FIG. 1, the image processing unit 23 is configured to generate a CT image 82 based on the acquired plurality of projection image data 81. The image processing unit 23 generates the CT image 82 by executing a reconstruction process on a set of projection image data 81 based on each of the first to third detection signals for each imaging angle 6 for 360 degrees (referred to as a projection data set). The CT image 82 is an image that reflects the three-dimensional structure of the subject 90 and is reconstructed by an arithmetic process from the X-ray images (projection image data 81) based on each of the first to third detection signals for each of the plurality of imaging angles 6. The CT image 82 can be in the form of a tomographic image, a three-dimensional stereoscopic image, or the like of the subject 90.

The imaging control unit 24 performs operation control of the X-ray tube 1 and operation control of the rotation mechanism 4. Specifically, for each of the plurality of imaging angles 6, the imaging control unit 24 performs control to cause electrons 71 to be irradiated simultaneously from the first electron irradiation unit 10a, the second electron irradiation unit 10b, and the third electron irradiation unit 10c.

Furthermore, the imaging control unit 24 performs control to make the first relative focal position 7a of the first electron irradiation unit 10a with respect to the subject 90 at the first imaging angle 6a, the second relative focal position 7b of the second electron irradiation unit 10b with respect to the subject 90 at the first imaging angle 6a, the third relative focal position 7c of the third electron irradiation unit 10c with respect to the subject 90 at the first imaging angle 6a, the fourth relative focal position 7d of the first electron irradiation unit 10a with respect to the subject 90 at the second imaging angle 6b, the fifth relative focal position 7e of the second electron irradiation unit 10b with respect to the subject 90 at the second imaging angle 6b, and the sixth relative focal position 7f of the third electron irradiation unit 10c with respect to the subject 90 at the second imaging angle 6b different from each other so as not to overlap.

The storage unit 25 is configured to include a volatile storage device and a non-volatile storage device. The storage unit 25 stores a program 80, various setting information (not shown) regarding X-ray image capturing by the X-ray imaging apparatus 100, and the like. The storage unit 25 stores the acquired plurality of projection image data 81 and the CT image 82 generated based on those projection image data 81.

The input/output unit 26 is configured by various interfaces for inputting and outputting signals to and from the control device 20. The input/output unit 26 is connected to the display device 27 and the input device 28. The display device 27 is, for example, a liquid crystal display device or the like. The input device 28 includes a keyboard and a mouse, etc. The image processing unit 23 acquires detection signals (image signals) from the detector 2 via the input/output unit 26. The main control unit 22 transmits instructions for starting or stopping imaging to the imaging control unit 24 via the input/output unit 26.

### (Configuration of X-Ray Tube)

As shown in FIG. 2, the X-ray tube 1 includes a target 11 and a plurality of electron irradiation units 10. The target 11 and the plurality of electron irradiation units 10 are housed in a vacuum vessel 12.

The X-ray tube 1 is configured to irradiate electrons 71 from the electron irradiation unit 10, which is a cathode, by applying a voltage between it and the target 11, which is an anode, and to cause the irradiated electrons 71 to collide with the target 11, thereby generating X-rays 70 from the target 11.

The plurality of electron irradiation units 10 are configured to irradiate electrons 71 to different focal positions 13 on the target 11, respectively. In the present embodiment, three electron irradiation units 10 are provided: a first electron irradiation unit 10a, a second electron irradiation unit 10b, and a third electron irradiation unit 10c. Note that the number of the plurality of electron irradiation units 10 is not particularly limited. The number of electron irradiation units 10 that the X-ray tube 1 has may be, for example, two, or four or more. The first electron irradiation unit 10a, the second electron irradiation unit 10b, and the third electron irradiation unit 10c are arranged side by side in a rotation plane orthogonal to the rotation axis 4a of the rotation mechanism 4.

Each of the first electron irradiation unit 10a, the second electron irradiation unit 10b, and the third electron irradiation unit 10c simultaneously irradiates electrons 71 toward different focal positions 13 on the target 11. Each of the first electron irradiation unit 10a, the second electron irradiation unit 10b, and the third electron irradiation unit 10c simultaneously irradiates electrons 71 for each of the plurality of imaging angles 6, based on the control of the imaging control unit 24. The first electron irradiation unit 10a irradiates electrons 71 toward a first focal position 13a (first focus) on the target 11. This causes X-rays 70 to be emitted from the first focal position 13a corresponding to the first electron irradiation unit 10a toward the detector 2. The second electron irradiation unit 10b irradiates electrons 71 toward a second focal position 13b (second focus) on the target 11. This causes X-rays 70 to be emitted from the second focal position 13b corresponding to the second electron irradiation unit 10b toward the detector 2. The third electron irradiation unit 10c irradiates electrons 71 toward a third focal position 13c (third focus) on the target 11. This causes X-rays 70 to be emitted from the third focal position 13c corresponding to the third electron irradiation unit 10c toward the detector 2.

Each of the first electron irradiation unit 10a, the second electron irradiation unit 10b, and the third electron irradiation unit 10c is arranged at a position where the distance from the first focal position 13a (first focus) to the rotation axis 4a passing through the subject placement unit 3, the distance from the second focal position 13b (second focus) to the rotation axis 4a passing through the subject placement unit 3, and the distance from the third focal position 13c (third focus) to the rotation axis 4a passing through the subject placement unit 3 are substantially equal. Therefore, the distance between each of the first to ninth relative focal positions (7a to 7i) and the rotation axis 4a passing through the subject placement unit 3 are each substantially equal.

That is, as shown in FIG. 4B, the imaging control unit 24 is configured to, with the change in the imaging angle 6, arrange each of the first to ninth relative focal positions (7a to 7i) at different positions that do not overlap with each other and are on an arc centered on the rotation axis 4a of the rotation mechanism 4.

As shown in FIG. 3, the X-ray tube 1 includes an electron irradiation unit moving mechanism 14. The electron irradiation unit moving mechanism 14 is configured to be able to change the distance between the first electron irradiation unit 10a and the second electron irradiation unit 10b, and the distance between the second electron irradiation unit 10b and the third electron irradiation unit 10c. The electron irradiation unit moving mechanism 14 is configured to be able to move at least two of the first electron irradiation unit 10a, the second electron irradiation unit 10b, and the third electron irradiation unit 10c in a direction substantially orthogonal to the optical axis direction of the X-rays 70 and a direction along the rotation axis 4a of the rotation mechanism 4. The electron irradiation unit moving mechanism 14 includes a motor or the like for moving the first electron irradiation unit 10a, the second electron irradiation unit 10b, and the third electron irradiation unit 10c.

The structure of the target 11 is not particularly limited. The target 11 may be either a reflection-type target or a transmission-type target. A reflection-type target has a surface inclined with respect to the electrons 71, and is a type of target where X-rays 70 are emitted by reflection from the inclined surface in a direction different from the incoming direction of the electrons 71. A transmission-type target has a pair of (front and back) surfaces orthogonal to the electrons 71, and is a type of target where, due to the collision of electrons 71 on one surface, X-rays 70 are emitted from the other surface so as to transmit through the target 11. Furthermore, the target 11 may be provided in a fixed state in the vacuum vessel 12, or may be rotated by a drive source such as a motor. That is, the X-ray tube 1 may have a so-called rotating anode structure.

One target 11 is provided for the plurality of electron irradiation units 10. One target 11 is provided for the first electron irradiation unit 10a, the second electron irradiation unit 10b, and the third electron irradiation unit 10c. The focal position 13 of each of the first electron irradiation unit 10a, the second electron irradiation unit 10b, and the third electron irradiation unit 10c is located dispersed on the surface of the target 11.

FIG. 3 shows a more detailed configuration example of the electron irradiation unit 10 and the target 11. FIG. 3 shows an example of a transmission-type target. In FIG. 3, the X-ray tube 1 includes an electron source unit 16 having a plurality of cold cathode electron sources 15 arranged on a plane. Each of the plurality of electron irradiation units 10 is constituted by a different group of the plurality of cold cathode electron sources 15.

The electron source unit 16 is one in which a large number of cold cathode electron sources 15 are formed in an array on a substrate 17 by applying semiconductor manufacturing technology. The substrate 17 is a flat plate of silicon, glass, or the like. A group constituted by a part of the plurality of cold cathode electron sources 15 arranged in an array constitutes one electron irradiation unit 10.

A group constituting one of the plurality of electron irradiation units 10 is composed of one or more cold cathode electron sources 15 that irradiate electrons 71 to the same focal position 13 on the target 11. One electron irradiation unit 10 includes one or more cold cathode electron sources 15. One electron irradiation unit 10 includes, for example, 100 or more or 1000 or more cold cathode electron sources 15. When one electron irradiation unit 10 is composed of a plurality of cold cathode electron sources 15, the set of electrons 71 irradiated from each of the plurality of cold cathode electron sources 15 constituting that electron irradiation unit 10 forms the electrons 71 irradiated from that electron irradiation unit 10. The electrons 71 are irradiated to one focal position 13 on the target 11. By the collision of the electrons 71, X-rays 70 are generated from the focal position 13 on the target 11. The spot (point-like region) where the electrons 71 collide at the focal position 13 becomes the focus of the X-rays 70. The imaging control unit 24 (see FIG. 1) controls a power source 18 so as to apply a predetermined voltage between a cathode electrode (not shown) and the target 11.

### (Control of Arrangement of First to Ninth Relative Focal Positions by Imaging Control Unit)

The imaging control unit 24 is configured to cause each of the first electron irradiation unit 10a, the second electron irradiation unit 10b, and the third electron irradiation unit 10c to simultaneously irradiate electrons 71 toward different focal positions 13 on the target 11. Thereby, first to third detection signals are detected by the detector 2, and projection image data 81 based on each of the first to third detection signals is generated in the image processing unit 23.

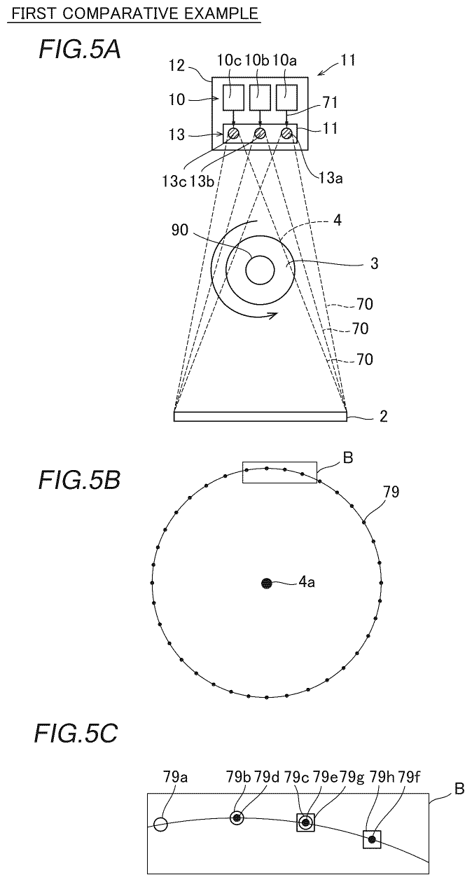

With reference to FIGS. 4 and 5, the positional relationship of the first to ninth relative focal positions (7a to 7i) will be described. FIG. 4A is a schematic diagram showing the first focal position 13a (first focus), the second focal position 13b (second focus), and the third focal position 13c (third focus), the subject 90, and the detector 2, as seen from the vertical direction, in an example of the present embodiment; FIG. 4B is a schematic diagram showing the positional relationship of the first to ninth relative focal positions (7a to 7i) in an example of the present embodiment; and FIG. 4C is an enlarged view of portion A in FIG. 4B. Also, FIG. 5A is a schematic diagram showing the first focal position 13a (first focus), the second focal position 13b (second focus), and the third focal position 13c (third focus), the subject 90, and the detector 2, as seen from the vertical direction, in a first comparative example; FIG. 5B is a schematic diagram showing the positional relationship of the first to ninth relative focal positions (79a to 79i) in the first comparative example; and FIG. 5C is an enlarged view of portion B in FIG. 5B.

As shown in FIG. 5C relating to the first comparative example, the second relative focal position 79b at the first imaging angle 6a and the fourth relative focal position 79d at the second imaging angle 6b overlap. Also, the third relative focal position 79c at the first imaging angle 6a, the fifth relative focal position 79e at the second imaging angle 6b, and the seventh relative focal position 79g at the third imaging angle 6c overlap. Also, the sixth relative focal position 79f at the second imaging angle 6b and the eighth relative focal position 79h at the third imaging angle 6c overlap.

That is, in the first comparative example, among the imaging angle 6 of the projection image data 81 based on the first detection signal originating from the first electron irradiation unit 10a, the imaging angle 6 of the projection image data 81 based on the second detection signal originating from the second electron irradiation unit 10b, and the imaging angle 6 of the projection image data 81 based on the third detection signal originating from the third electron irradiation unit 10c at the first imaging angle 6a; the imaging angle 6 of the projection image data 81 based on the first detection signal originating from the first electron irradiation unit 10a, the imaging angle 6 of the projection image data 81 based on the second detection signal originating from the second electron irradiation unit 10b, and the imaging angle 6 of the projection image data 81 based on the third detection signal originating from the third electron irradiation unit 10c at the second imaging angle 6b; and the imaging angle 6 of the projection image data 81 based on the first detection signal originating from the first electron irradiation unit 10a, the imaging angle 6 of the projection image data 81 based on the second detection signal originating from the second electron irradiation unit 10b, and the imaging angle 6 of the projection image data 81 based on the third detection signal originating from the third electron irradiation unit 10c at the third imaging angle 6c, projection image data 81 of the same imaging angle 6 is included. In this case, since these projection image data 81 of the same imaging angle 6 can be said to be substantially the same, the number of imaging angles 6 in the projection image data 81 cannot be increased.

In contrast, in the X-ray imaging apparatus 100 according to the present embodiment, as shown in the example of FIG. 4C, the first to ninth relative focal positions (7a to 7i) are all arranged at different positions without overlapping. Therefore, the number of imaging angles 6 in the projection image data 81 can be increased. The imaging control unit 24 performs control to make each of the relative focal positions 7 in the first relative focal position 7a, the second relative focal position 7b, and the third relative focal position 7c at the first imaging angle 6a; the fourth relative focal position 7d, the fifth relative focal position 7e, and the sixth relative focal position 7f at the second imaging angle 6b; and the seventh relative focal position 7g, the eighth relative focal position 7h, and the ninth relative focal position 7i at the third imaging angle 6c, all different from each other so as not to overlap.

Specifically, the imaging control unit 24 is configured to make the first to ninth relative focal positions (7a to 7i) different from each other so as not to overlap by adjusting at least one of an inter-focal distance p (see FIG. 3) between the first focus (first focal position 13a) of the first electron irradiation unit 10a and the second focus (second focal position 13b) of the second electron irradiation unit 10b, a focus-to-subject distance d (see FIG. 2) between the first focus (first focal position 13a) and the subject 90, the number of imaging angles 6 (number of views) v, a rotational angle range θ by the rotation mechanism 4, the number of foci N on the target 11, and the number m of relative focal positions 7 including the second relative focal position 7b existing between the first relative focal position 7a and the second relative focal position 7b.

Here, the inter-focal distance p between the first focus (first focal position 13a) of the first electron irradiation unit 10a and the second focus (second focal position 13b) of the second electron irradiation unit 10b, and the inter-focal distance p between the second focus (second focal position 13b) of the second electron irradiation unit 10b and the third focus (third focal position 13c) of the third electron irradiation unit 10c are arranged to be substantially equal. Therefore, the inter-focal distance p may be the inter-focal distance p between the second focus (second focal position 13b) of the second electron irradiation unit 10b and the third focus (third focal position 13c) of the third electron irradiation unit 10c.

Furthermore, the focus-to-subject distance d between the first focus (first focal position 13a) and the subject 90, the focus-to-subject distance d between the second focus (second focal position 13b) and the subject 90, and the focus-to-subject distance d between the third focus (third focal position 13c) and the subject 90 are each configured to be substantially equal. Therefore, the focus-to-subject distance d may be the focus-to-subject distance d between the second focus (second focal position 13b) or the third focus (third focal position 13c) and the subject 90. Also, regarding the number m of relative focal positions 7, it may be the number m of relative focal positions 7 including the third relative focal position 7c existing between the second relative focal position 7b and the third relative focal position 7c.

More specifically, the imaging control unit 24 is configured to make the first to ninth relative focal positions (7a to 7i) different from each other so as not to overlap, based on the following formula (1).

$$\begin{matrix}[ Formula 1 ] & \\ p = d tan ( \frac{π m Θ}{180 NV} ) s . t . mod ( m , N ) \neq 0 & ( 1 )\end{matrix}$$

Here, p is the inter-focal distance, d is the focus-to-subject distance, v is the number of imaging angles 6, θ is the rotational angle range by the rotation mechanism 4, N is the number of foci on the target 11, and m is the number of relative focal positions 7 including the second relative focal position 7b existing between the first relative focal position 7a and the second relative focal position 7b. m and N are such that the remainder of dividing m by N is not 0.

Note that in the present embodiment, the number of foci N on the target 11 is 3 and is stored as a fixed value in the storage unit 25. Furthermore, before the start of imaging of the subject 90 by the imaging unit 5, a user can set the magnification of the subject 90 in the projection image data 81, the rotational angle range θ, and the number of imaging angles 6 (number of views) v using the input device 28. The imaging control unit 24 acquires information on the fixed value of the number of foci N on the target 11 stored in the storage unit 25, and information on the magnification of the subject 90 in the projection image data 81, information on the rotational angle range θ, and information on the number of imaging angles v, which are input by the user via the input device 28.

Here, the inter-focal distance p corresponds to the distance between adjacent electron irradiation units 10 among the plurality of electron irradiation units 10. The imaging control unit 24 acquires information on the inter-focal distance p based on the distance between the first electron irradiation unit 10a and the second electron irradiation unit 10b.

Furthermore, the focus-to-subject distance d corresponds to the magnification of the subject 90 in the projection image data 81, which can be set by the user. The imaging control unit 24 acquires information on the focus-to-subject distance d from the information on the magnification of the subject 90 in the projection image data 81 by accepting the input of the information on the magnification of the subject 90 in the projection image data 81 from the user via the input device 28. The method for acquiring the information on the focus-to-subject distance d based on the information on the magnification of the subject 90 in the projection image data 81 is not particularly limited, and can be appropriately acquired by various methods.

The imaging control unit 24 acquires parameters other than the acquired information, such that the above formula (1) is satisfied, based on the information on the fixed value of the number of foci N, the information acquired based on the user's input, and the above formula (1). As an example, the imaging control unit 24 acquires the value of the inter-focal distance p and the value of the number m of relative focal positions 7 including the second relative focal position 7b existing between the first relative focal position 7a and the second relative focal position 7b, such that the above formula (1) can be satisfied.

The imaging control unit 24 adjusts the inter-focal distance p and the number m of relative focal positions 7 based on the value of the inter-focal distance p and the value of the number m of relative focal positions 7 including the second relative focal position 7b existing between the first relative focal position 7a and the second relative focal position 7b, which are acquired by the calculation of the above formula (1).

Specifically, the imaging control unit 24 moves the first electron irradiation unit 10a, the second electron irradiation unit 10b, and the third electron irradiation unit 10c via the electron irradiation unit moving mechanism 14 such that the inter-focal distance p between the first focus (first focal position 13a) of the first electron irradiation unit 10a and the second focus (second focal position 13b) of the second electron irradiation unit 10b, and the inter-focal distance p between the second focus (second focal position 13b) of the second electron irradiation unit 10b and the third focus (third focal position 13c) of the third electron irradiation unit 10c become the acquired value of the inter-focal distance p, and the number m of relative focal positions 7 including the second relative focal position 7b existing between the first relative focal position 7a and the second relative focal position 7b becomes the acquired number m of relative focal positions 7.

After the movement of the first electron irradiation unit 10a, the second electron irradiation unit 10b, and the third electron irradiation unit 10c via the electron irradiation unit moving mechanism 14 by the imaging control unit 24, the main control unit 22 starts imaging by the imaging unit 5 based on receiving a user's input operation for starting imaging by the imaging unit 5 via the input device 28.

### (Number of Relative Focal Positions)

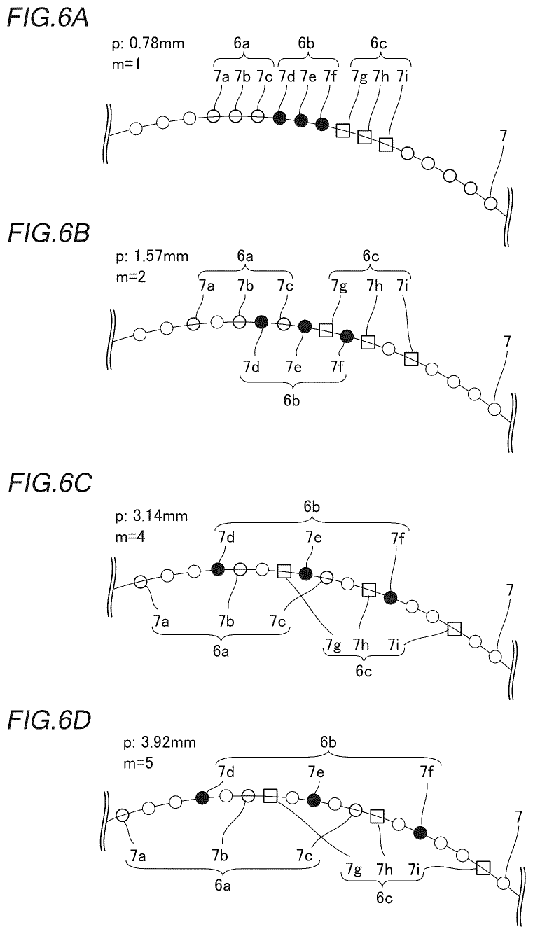

With reference to FIGS. 6A to 6D, the number m of relative focal positions 7 including the second relative focal position 7b existing between the first relative focal position 7a and the second relative focal position 7b will be described. Note that regarding the number m of relative focal positions 7, the number m of relative focal positions 7 including the second relative focal position 7b existing between the first relative focal position 7a and the second relative focal position 7b, and the number m of relative focal positions 7 including the third relative focal position 7c existing between the second relative focal position 7b and the third relative focal position 7c are the same.

In an example of the control of the arrangement of the first to ninth relative focal positions (7a to 7i) by the imaging control unit 24 described above, the imaging control unit 24 acquires the value of the inter-focal distance p and the value of the number m of relative focal positions 7 including the second relative focal position 7b existing between the first relative focal position 7a and the second relative focal position 7b, based on the above formula (1). FIGS. 6A to 6D show an example of the positional relationship of the first to sixth relative focal positions (7a to 7f), the seventh relative focal position 7g of the first electron irradiation unit 10a with respect to the subject 90 at the third imaging angle 6c, the eighth relative focal position 7h of the second electron irradiation unit 10b with respect to the subject 90 at the third imaging angle 6c, and the ninth relative focal position 7i of the third electron irradiation unit 10c with respect to the subject 90 at the third imaging angle 6c, for the value of the number m of relative focal positions 7 and the value of the inter-focal distance p acquired by the above formula (1). Note that in the example of the positional relationship of the relative focal positions 7, the focus-to-subject distance d is 75 mm, the number v of imaging angles 6 is 100, the rotational angle range θ is 180 degrees, and the number N of foci on the target 11 is 3.

FIG. 6A shows an example of the positional relationship of the first to ninth relative focal positions (7a to 7i) when the number m of relative focal positions 7 acquired by the above formula (1) is 1, and the inter-focal distance p is 0.78 mm. As shown in FIG. 6A, the number m of relative focal positions 7 including the fifth relative focal position 7e existing between the fourth relative focal position 7d and the fifth relative focal position 7e at the second imaging angle 6b is 1. In this case, the first to third relative focal positions (7a to 7c) at the first imaging angle 6a, the fourth to sixth relative focal positions (7d to 7f) at the second imaging angle 6b, and the seventh to ninth relative focal positions (7g to 7i) at the third imaging angle 6c are all different from each other without overlapping.

FIG. 6B shows an example of the positional relationship of the first to ninth relative focal positions (7a to 7i) when the number m of relative focal positions 7 acquired by the above formula (1) is 2, and the inter-focal distance p is 1.57 mm. As shown in FIG. 6B, the number m of relative focal positions 7 including the fifth relative focal position 7e existing between the fourth relative focal position 7d and the fifth relative focal position 7e at the second imaging angle 6b is 2. Also in this case, the first to third relative focal positions (7a to 7c) at the first imaging angle 6a, the fourth to sixth relative focal positions (7d to 7f) at the second imaging angle 6b, and the seventh to ninth relative focal positions (7g to 7i) at the third imaging angle 6c are all different from each other without overlapping.

FIG. 6C shows an example of the positional relationship of the first to ninth relative focal positions (7a to 7i) when the number m of relative focal positions 7 acquired by the above formula (1) is 4, and the inter-focal distance p is 3.14 mm. As shown in FIG. 6C, the number m of relative focal positions 7 including the fifth relative focal position 7e existing between the fourth relative focal position 7d and the fifth relative focal position 7e at the second imaging angle 6b is 4. Also in this case, the first to third relative focal positions (7a to 7c) at the first imaging angle 6a, the fourth to sixth relative focal positions (7d to 7f) at the second imaging angle 6b, and the seventh to ninth relative focal positions (7g to 7i) at the third imaging angle 6c are all different from each other without overlapping.

FIG. 6D shows an example of the positional relationship of the first to ninth relative focal positions (7a to 7i) when the number m of relative focal positions 7 acquired by the above formula (1) is 5, and the inter-focal distance p is 3.92 mm. As shown in FIG. 6D, the number m of relative focal positions 7 including the fifth relative focal position 7e existing between the fourth relative focal position 7d and the fifth relative focal position 7e at the second imaging angle 6b is 5. Also in this case, the first to third relative focal positions (7a to 7c) at the first imaging angle 6a, the fourth to sixth relative focal positions (7d to 7f) at the second imaging angle 6b, and the seventh to ninth relative focal positions (7g to 7i) at the third imaging angle 6c are all different from each other without overlapping.

In the examples shown in FIGS. 6A to 6D, where the value of the inter-focal distance p and the value of the number m of relative focal positions 7 including the second relative focal position 7b existing between the first relative focal position 7a and the second relative focal position 7b are acquired based on the above formula (1), the projection image data 81 based on the first detection signal originating from the first electron irradiation unit 10a, the projection image data 81 based on the second detection signal originating from the second electron irradiation unit 10b, and the projection image data 81 based on the third detection signal originating from the third electron irradiation unit 10c at the first to third imaging angles 6c do not include projection image data 81 of the same imaging angle 6.

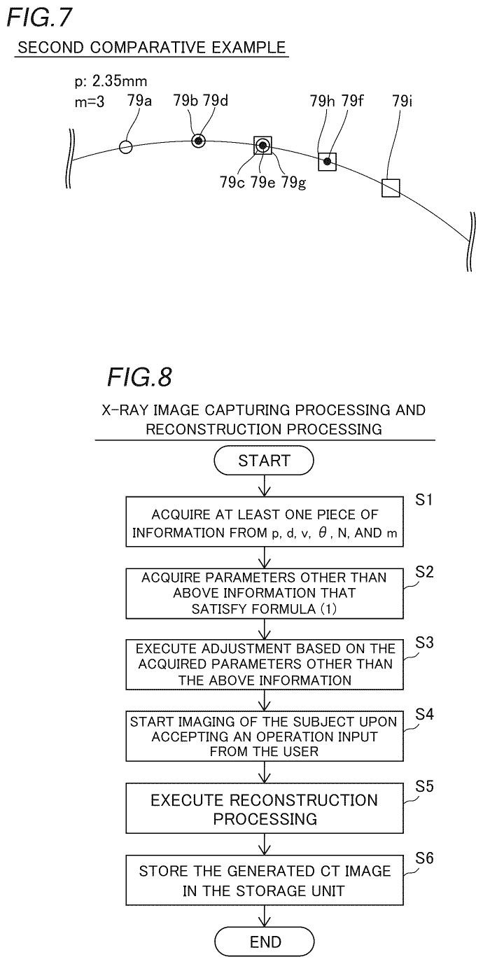

Note that in the above formula (1), the remainder of dividing the number m of relative focal positions 7 by the number N of foci on the target 11 (3 in the above example) is not 0. In contrast, as in the second comparative example shown in FIG. 7, when the number m of relative focal positions 79 is 3, the remainder of dividing the number m (3) of relative focal positions 79 by the number N (3) of foci on the target 11 is 0. In this case, the second relative focal position 79b at the first imaging angle 6a and the fourth relative focal position 79d at the second imaging angle 6b overlap. Also, the third relative focal position 79c at the first imaging angle 6a, the fifth relative focal position 79e at the second imaging angle 6b, and the seventh relative focal position 79g at the third imaging angle 6c overlap. Also, the sixth relative focal position 79f at the second imaging angle 6b and the eighth relative focal position 79h at the third imaging angle 6c overlap. That is, the projection image data 81 based on the third detection signal originating from the third electron irradiation unit 10c at the first imaging angle 6a, the projection image data 81 based on the second detection signal originating from the second electron irradiation unit 10b at the second imaging angle 6b, and the projection image data 81 based on the first detection signal originating from the first electron irradiation unit 10a at the third imaging angle 6c are projection image data 81 of the same imaging angle 6.

### (Reconstruction Processing)

The reconstruction processing using the plurality of projection image data 81 by the image processing unit 23 (see FIG. 1) will be briefly described.

The data used for the reconstruction processing will be described. The storage unit 25 of the control device 20 (see FIG. 1) stores the program 80 executed by the image processing unit 23 and the plurality of projection image data 81. Each of the plurality of projection image data 81 is stored in association with the imaging angle 6 at which that projection image data 81 was acquired, information on the electron irradiation unit 10 (information for identifying which of the first electron irradiation unit 10a, the second electron irradiation unit 10b, and the third electron irradiation unit 10c it is), and information on the relative focal position 7. Furthermore, the storage unit 25 stores the generated CT image 82.

Here, for each of the plurality of imaging angles 6, the detector 2 simultaneously detects the X-rays 70 emitted from the first focus corresponding to the first electron irradiation unit 10a and transmitted through the subject 90, the X-rays 70 emitted from the second focus corresponding to the second electron irradiation unit 10b and transmitted through the subject 90, and the X-rays 70 emitted from the third focus corresponding to the third electron irradiation unit 10c and transmitted through the subject 90. That is, since the detection signal (image signal) acquired by the detector 2 is a detection signal (image signal) in which the X-rays 70 emitted from each of the first focus, the second focus, and the third focus are overlapped, general analytical CT reconstruction methods such as the filtered back-projection method cannot be applied.

Therefore, in the present embodiment, reconstruction processing using an iterative approximation method is performed. The image processing unit 23 performs iterative calculations while estimating the contribution ratio from each of the first focus, the second focus, and the third focus, using the iterative approximation method. Thereby, the image processing unit 23 can acquire, from the detection signal (image signal) in which the X-rays 70 emitted from each of the first focus, the second focus, and the third focus are overlapped, the detection signal (image signal) of the X-rays 70 emitted from the first focus, the detection signal (image signal) of the X-rays 70 emitted from the second focus, and the detection signal (image signal) of the X-rays 70 emitted from the third focus, respectively. Therefore, a high-quality reconstructed image can be generated. Note that the method for acquiring the detection signal (image signal) for each focus from the detection signal (image signal) in which the X-rays 70 emitted from each of a plurality of foci are overlapped, using the iterative approximation method, is a known technique disclosed, for example, in “Maximum-Likelihood Transmission Image Reconstruction for Overlapping Transmission Beams” by Daniel F. Yu, Jeffrey A. Fessler, and Edward P. Ficaro, IEEE transactions on medical imaging 19.11 (2000): pp. 1094-1105, and thus detailed description thereof is omitted here.

As a result of the reconstruction processing using the iterative approximation method, the image processing unit 23 generates a CT image 82 of the subject 90.

### (X-Ray Image Capturing Processing and Reconstruction Processing)

With reference to FIG. 8, the X-ray image capturing processing and reconstruction processing by the control unit 21 will be described. Note that the order of the processing steps can be interchanged or executed simultaneously as long as they do not contradict each other.

In step S1, the imaging control unit 24 acquires at least one of information on the inter-focal distance p, information on the focus-to-subject distance d, information on the number v of imaging angles 6, information on the rotational angle range θ, information on the number N of foci on the target 11, and information on the number m of relative focal positions 7, from the storage unit 25 or by accepting an input from a user via the input device 28. Thereafter, the processing proceeds to step S2.

In step S2, the imaging control unit 24 acquires parameters other than the acquired information, such that the above formula (1) can be satisfied, based on the acquired information and the above formula (1). Thereafter, the processing proceeds to step S3.

In step S3, the imaging control unit 24 performs an adjustment based on the parameters other than the acquired information, which were acquired by the calculation of the above formula (1). Thereafter, the processing proceeds to step S4.

In step S4, the main control unit 22 transmits a signal instructing the start of the imaging operation to the imaging control unit 24 by accepting an operation input from a user via the input device 28, and the imaging control unit 24, upon receiving the signal from the main control unit 22, controls the X-ray tube 1 and the rotation mechanism 4, and starts imaging of the subject 90. Then, the imaging control unit 24 performs imaging of projection image data 81 for a predetermined angular range. Thereafter, the processing proceeds to step S5.

In step S5, the image processing unit 23 performs reconstruction processing based on each projection image data 81 included in the projection data set. Thereafter, the processing proceeds to step S7. (Note: There is likely a typo in the original document, jumping from S5 to S7. Assuming it should be S6.)

In step S6, the image processing unit 23 stores the generated CT image 82 in the storage unit 25. Thereafter, the processing ends.

(Comparison with Third and Fourth Comparative Examples)

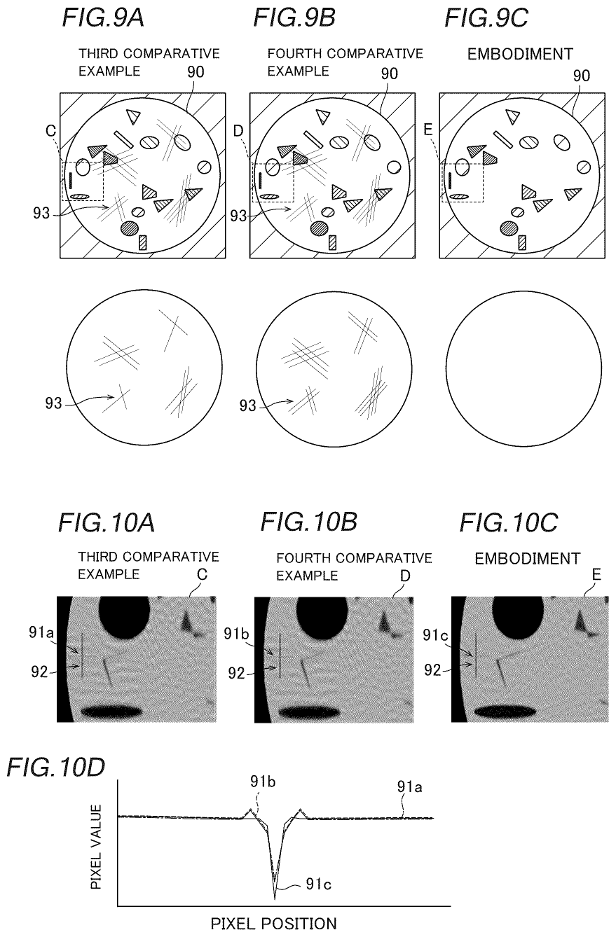

With reference to FIGS. 9A to 9C, a comparison result between tomographic images acquired by X-ray imaging apparatuses in a third comparative example and a fourth comparative example, and a tomographic image acquired by the X-ray imaging apparatus 100 in the present embodiment will be described.

Note that the subject 90 shown in FIGS. 9A to 9C is the same subject 90. The subject 90 is a cylindrical sample made of resin, and the interior of the subject 90 includes a material with a low absorption coefficient for X-rays 70 or a gap. Furthermore, the upper diagrams in each of FIGS. 9A to 9C are tomographic images along the horizontal direction of the cylindrical subject 90. Also, the lower diagrams in each of FIGS. 9A to 9C are difference images between the tomographic image in the upper diagram and an image of a cut surface obtained by cutting the cylindrical subject 90 at a position corresponding to the tomographic image. That is, the lower diagrams in each of FIGS. 9A to 9C are images in which artifacts 93 in the tomographic image of the upper diagram are extracted.

FIG. 9A is a tomographic image acquired by an X-ray imaging apparatus in a third comparative example. The X-ray imaging apparatus in the third comparative example includes a single-focus X-ray tube composed of a target and a single electron irradiation unit. In the upper and lower diagrams of FIG. 9A, streak-like artifacts 93 extending radially, caused by a small number of imaging angles (few views), can be confirmed.

Furthermore, FIG. 9B is a tomographic image acquired by an X-ray imaging apparatus in a fourth comparative example. The X-ray imaging apparatus in the fourth comparative example includes a triple-focus X-ray tube composed of a target and three electron irradiation units. However, unlike the X-ray imaging apparatus 100 in the present embodiment, the X-ray imaging apparatus in the fourth comparative example does not perform control to make the first to third relative focal positions (7a to 7c) at the first imaging angle 6a, the fourth to sixth relative focal positions (7d to 7f) at the second imaging angle 6b, and the seventh to ninth relative focal positions (7g to 7i) at the third imaging angle 6c different from each other so as not to overlap. That is, in the X-ray imaging apparatus in the fourth comparative example, the first to third relative focal positions (7a to 7c) at the first imaging angle 6a, the fourth to sixth relative focal positions (7d to 7f) at the second imaging angle 6b, and the seventh to ninth relative focal positions (7g to 7i) at the third imaging angle 6c include overlapping relative focal positions. Therefore, in the upper and lower diagrams of FIG. 9B, many streak-like artifacts 93 extending radially, caused by a small number of imaging angles (few views), can be confirmed.

In contrast, FIG. 9C is a tomographic image acquired by the X-ray imaging apparatus 100 in the present embodiment. By the imaging control unit 24, control is performed to make the first to third relative focal positions (7a to 7c) at the first imaging angle 6a, the fourth to sixth relative focal positions (7d to 7f) at the second imaging angle 6b, and the seventh to ninth relative focal positions (7g to 7i) at the third imaging angle 6c different from each other so as not to overlap. Therefore, in the upper and lower diagrams of FIG. 9C, it can be confirmed that there are almost no streak-like artifacts 93 extending radially, caused by a small number of imaging angles (few views), compared to FIG. 9A of the third comparative example and FIG. 9B of the fourth comparative example. Thus, in the X-ray imaging apparatus 100 of the present embodiment, artifacts caused by a small number of imaging angles can be reduced.

Furthermore, FIG. 10A is an enlarged view of portion C in the upper diagram of FIG. 9A according to the third comparative example, FIG. 10B is an enlarged view of portion D in the upper diagram of FIG. 9B according to the fourth comparative example, and FIG. 10C is an enlarged view of portion E in the upper diagram of FIG. 9C according to the present embodiment. Also, FIG. 10D is a graph showing pixel values in the portions of lines 91a to 91c in FIGS. 10A to 10C. Comparing FIGS. 10A to 10C, it can be confirmed that in FIG. 10C according to the present embodiment, there are fewer artifacts 93 than in FIG. 10A according to the third comparative example and FIG. 10B according to the fourth comparative example. Also, from FIGS. 10A to D, it can be confirmed that in the tomographic image acquired by the X-ray imaging apparatus 100 of the present embodiment, the contrast of the structure 92 appearing elongated vertically is improved.

### [Modifications]

It should be understood that the embodiments and examples disclosed herein are illustrative in all respects and not restrictive. The scope of the present invention is indicated by the claims rather than by the description of the embodiments and examples above, and all changes (modifications) within the meaning and scope equivalent to the claims are intended to be included therein.

For example, in the X-ray tube, the inter-focal distance p between the first focus of the first electron irradiation unit and the second focus of the second electron irradiation unit, and the number N of foci on the target may be preset such that the first relative focal position of the first electron irradiation unit with respect to the subject at a first imaging angle, the second relative focal position of the second electron irradiation unit with respect to the subject at the first imaging angle, the third relative focal position of the first electron irradiation unit with respect to the subject at a second imaging angle, and the fourth relative focal position of the second electron irradiation unit with respect to the subject at the second imaging angle are different from each other without overlapping. Also, for example, the imaging control unit may be configured to be able to individually control the electron irradiation from the plurality of electron irradiation units, and may be configured to select two or more of the plurality of electron irradiation units to irradiate electrons simultaneously. In this case, since the inter-focal distance p can be appropriately changed according to the selected electron irradiation units, the electron irradiation unit moving mechanism may not be provided.

Also, for example, as long as the first to fourth relative focal positions are arranged at different positions that do not overlap with each other with the change in imaging angle, they may be arranged on the contour line of a polygon instead of on an arc centered on the rotation axis of the rotation mechanism.

Also, for example, the first electron irradiation unit and the second electron irradiation unit may be arranged displaced in the vertical direction with respect to the rotation plane orthogonal to the rotation axis of the rotation mechanism.

Also, for example, the imaging control unit may be configured to make the first to ninth relative focal positions different from each other so as not to overlap by replacing at least one of the inter-focal distance p, the focus-to-subject distance d, the number v of imaging angles, the rotational angle range θ by the rotation mechanism, and the number m of relative focal positions for the number N of foci on the target with another parameter, or by adding another parameter and adjusting at least one of these parameters.

Also, for example, the X-ray imaging apparatus may be used for medical purposes. In this case, the subject is a living body to be examined.

Also, for example, the plurality of electron irradiation units may be constituted by hot cathode electron sources.

### [Aspects]

It will be understood by those skilled in the art that the exemplary embodiments described above are specific examples of the following aspects.

### (Item 1)

An X-ray imaging apparatus, comprising:
an X-ray tube including at least a first electron irradiation unit and a second electron irradiation unit for irradiating electrons to different focal positions on a target;
a detector for detecting X-rays emitted from the X-ray tube;
a subject placement unit arranged between the X-ray tube and the detector, for placing a subject thereon;
a rotation mechanism for rotating one of an imaging unit including the X-ray tube and the detector, and the subject placement unit, so as to change an imaging angle of the subject; and
a control unit for acquiring a plurality of projection image data at each of a plurality of the imaging angles from the detector, and for generating a CT image based on the acquired plurality of projection image data,
wherein the control unit performs:
a control to cause electrons to be irradiated simultaneously from the first electron irradiation unit and the second electron irradiation unit for each of the plurality of the imaging angles; and
a control to make a first relative focal position of the first electron irradiation unit with respect to the subject at a first imaging angle, a second relative focal position of the second electron irradiation unit with respect to the subject at the first imaging angle, a third relative focal position of the first electron irradiation unit with respect to the subject at a second imaging angle, and a fourth relative focal position of the second electron irradiation unit with respect to the subject at the second imaging angle different from each other so as not to overlap.

By simultaneously irradiating electrons from a plurality of electron irradiation units including the first electron irradiation unit and the second electron irradiation unit to different focal positions on the target for each of the plurality of imaging angles, a plurality of projection image data corresponding to the number of the plurality of electron irradiation units can be acquired for each imaging angle. Therefore, the number of acquired projection image data can be increased without increasing the imaging time. Furthermore, by making the first to fourth relative focal positions different from each other so as not to overlap, the imaging angles of the subject in the plurality of projection image data acquired for each imaging angle, corresponding to the number of the plurality of electron irradiation units, can be made different from each other. Thus, projection image data at different imaging angles can be acquired for each of the acquired plurality of projection image data. Therefore, projection image data for a sufficient number of imaging angles (number of views) can be acquired from the increased projection image data. For these reasons, it is possible to reduce artifacts caused by a small number of imaging angles while suppressing an increase in the imaging time required for acquiring projection image data.

### (Item 2)

The X-ray imaging apparatus according to item 1, wherein the control unit is configured to, with the change in the imaging angle, arrange the first relative focal position, the second relative focal position, the third relative focal position, and the fourth relative focal position at different positions that do not overlap with each other and are on an arc centered on a rotation axis of the rotation mechanism.

In this case, since the distance between each of the first to fourth relative focal positions and the subject can be kept constant with the change in imaging angle, when generating a CT image based on the projection image data acquired at each of the first to fourth relative focal positions, the CT image can be more easily generated by the reconstruction processing than in a case where the distances between each of the first to fourth relative focal positions and the subject are different from each other.

### (Item 3)

The X-ray imaging apparatus according to item 1 or 2, wherein the first electron irradiation unit and the second electron irradiation unit simultaneously irradiate electrons for each of the plurality of the imaging angles based on the control of the control unit, and are arranged side by side in a rotation plane orthogonal to a rotation axis of the rotation mechanism.

In this case, since the first electron irradiation unit and the second electron irradiation unit can be arranged on the same plane at each of the first to fourth relative focal positions with the change in imaging angle, when generating a CT image based on the projection image data acquired at each of the first to fourth relative focal positions, the CT image can be more easily generated by the reconstruction processing compared to a case where the first electron irradiation unit and the second electron irradiation unit are not arranged on the same plane at each of the first to fourth relative focal positions.

### (Item 4)

The X-ray imaging apparatus according to any one of items 1 to 3, wherein the control unit makes the first relative focal position, the second relative focal position, the third relative focal position, and the fourth relative focal position different from each other so as not to overlap by adjusting at least one of an inter-focal distance between a first focus of the first electron irradiation unit and a second focus of the second electron irradiation unit, a focus-to-subject distance between the first focus or the second focus and the subject, a number of the imaging angles, a rotational angle range by the rotation mechanism, a number of foci on the target, and a number of relative focal positions including the second relative focal position existing between the first relative focal position and the second relative focal position.

In this case, the control unit can easily make the first to fourth relative focal positions different from each other so as not to overlap by adjusting at least one of the inter-focal distance, the focus-to-subject distance, the number of imaging angles, the rotational angle range, the number of foci, and the number of relative focal positions. Therefore, since projection image data for a sufficient number of imaging angles (number of views) can be acquired from the increased projection image data, artifacts caused by a small number of acquired projection image data due to a small number of imaging angles can be easily reduced while suppressing an increase in the imaging time required for acquiring projection image data.

### (Item 5)

The X-ray imaging apparatus according to item 4, wherein the control unit is configured to make the first relative focal position, the second relative focal position, the third relative focal position, and the fourth relative focal position different from each other so as not to overlap, based on the following formula (1).

$$\begin{matrix}[ Formula 2 ] & \\ p = d tan ( \frac{π m Θ}{180 NV} ) s . t . mod ( m , N ) \neq 0 & ( 1 )\end{matrix}$$

Here, p is the inter-focal distance, d is the focus-to-subject distance, v is the number of the imaging angles, θ is the rotational angle range by the rotation mechanism, N is the number of foci on the target, and m is the number of relative focal positions including the second relative focal position existing between the first relative focal position and the second relative focal position.

In this case, the control unit can more easily make the first to fourth relative focal positions different from each other so as not to overlap, based on the above formula (1). Therefore, artifacts caused by a small number of acquired projection image data due to a small number of imaging angles can be more easily reduced while suppressing an increase in the imaging time required for acquiring projection image data.

### (Item 6)

The X-ray imaging apparatus according to any one of items 1 to 5,
wherein the X-ray tube includes the target, and at least the first electron irradiation unit and the second electron irradiation unit for irradiating electrons to different focal positions on the target, respectively, and
the detector is configured to simultaneously detect X-rays based on the electrons irradiated by the first electron irradiation unit and X-rays based on the electrons irradiated by the second electron irradiation unit.

In this case, since the X-ray tube includes the target and at least the first electron irradiation unit and the second electron irradiation unit for simultaneously irradiating electrons to different focal positions on the target, and the detector can simultaneously detect the X-rays based on the first electron irradiation unit and the X-rays based on the second electron irradiation unit, an increase in the number of parts and complexity of the structure can be suppressed, compared to a case of providing a plurality of X-ray tubes including an X-ray tube with a target and a first electron irradiation unit, and an X-ray tube with a target and a second electron irradiation unit.

### (Item 7)

An X-ray tube used in an X-ray imaging apparatus that acquires a plurality of projection image data at a plurality of imaging angles and generates a CT image based on the acquired plurality of the projection image data, the X-ray tube comprising:
at least a first electron irradiation unit and a second electron irradiation unit for simultaneously irradiating electrons to different focal positions of a target,
wherein an inter-focal distance between a first focus of the first electron irradiation unit and a second focus of the second electron irradiation unit, and a number of foci on the target are preset such that a first relative focal position of the first electron irradiation unit with respect to a subject at a first imaging angle, a second relative focal position of the second electron irradiation unit with respect to the subject at the first imaging angle, a third relative focal position of the first electron irradiation unit with respect to the subject at a second imaging angle, and a fourth relative focal position of the second electron irradiation unit with respect to the subject at the second imaging angle are different from each other without overlapping.

By simultaneously irradiating electrons from a plurality of electron irradiation units including the first electron irradiation unit and the second electron irradiation unit to different focal positions on the target for each of the plurality of imaging angles, a plurality of projection image data corresponding to the number of the plurality of electron irradiation units can be acquired for each imaging angle. Therefore, the number of acquired projection image data can be increased without increasing the imaging time. Furthermore, because the inter-focal distance between the first focus of the first electron irradiation unit and the second focus of the second electron irradiation unit, and the number of foci on the target are preset such that the first to fourth relative focal positions are different from each other without overlapping, projection image data at different imaging angles can be acquired for each of the acquired plurality of projection image data. Therefore, projection image data for a sufficient number of imaging angles (number of views) can be acquired from the increased projection image data. For these reasons, it is possible to reduce artifacts caused by a small number of imaging angles while suppressing an increase in the imaging time required for acquiring projection image data.

### REFERENCE SIGNS LIST

1 X-ray tube
2 detector
3 subject placement unit
4 rotation mechanism
4a rotation axis
5 imaging unit
6 imaging angle
6a first imaging angle
6b second imaging angle
6c third imaging angle
7 relative focal position
7a first relative focal position
7b second relative focal position
7c third relative focal position
7d fourth relative focal position
7e fifth relative focal position
7f sixth relative focal position
7g seventh relative focal position
7h eighth relative focal position
7i ninth relative focal position
10 electron irradiation unit
10a first electron irradiation unit
10b second electron irradiation unit
10c third electron irradiation unit
11 target
13 focal position
13a first focal position
13b second focal position
13c third focal position
21 control unit
70 X-ray
71 electron
81 projection image data
82 CT image
90 subject
100 X-ray imaging apparatus

1. An X-ray imaging apparatus, comprising:
an X-ray tube including at least a first electron irradiation unit and a second electron irradiation unit for irradiating electrons to different focal positions on a target;
a detector for detecting X-rays emitted from the X-ray tube;
a subject placement unit arranged between the X-ray tube and the detector, for placing a subject thereon;
a rotation mechanism for rotating one of an imaging unit including the X-ray tube and the detector, and the subject placement unit, so as to change an imaging angle of the subject; and
a control unit for acquiring a plurality of projection image data at each of a plurality of the imaging angles from the detector, and for generating a CT image based on the acquired plurality of projection image data,
wherein the control unit performs:
a control to cause electrons to be irradiated simultaneously from the first electron irradiation unit and the second electron irradiation unit for each of the plurality of the imaging angles; and
a control to make a first relative focal position of the first electron irradiation unit with respect to the subject at a first imaging angle, a second relative focal position of the second electron irradiation unit with respect to the subject at the first imaging angle, a third relative focal position of the first electron irradiation unit with respect to the subject at a second imaging angle, and a fourth relative focal position of the second electron irradiation unit with respect to the subject at the second imaging angle different from each other so as not to overlap.

2. The X-ray imaging apparatus according to claim 1, wherein the control unit is configured to, with the change in the imaging angle, arrange the first relative focal position, the second relative focal position, the third relative focal position, and the fourth relative focal position at different positions that do not overlap with each other and are on an arc centered on a rotation axis of the rotation mechanism.

3. The X-ray imaging apparatus according to claim 1, wherein the first electron irradiation unit and the second electron irradiation unit simultaneously irradiate electrons for each of the plurality of the imaging angles based on the control of the control unit, and are arranged side by side in a rotation plane orthogonal to a rotation axis of the rotation mechanism.

4. The X-ray imaging apparatus according to claim 1, wherein the control unit makes the first relative focal position, the second relative focal position, the third relative focal position, and the fourth relative focal position different from each other so as not to overlap by adjusting at least one of an inter-focal distance between a first focus of the first electron irradiation unit and a second focus of the second electron irradiation unit, a focus-to-subject distance between the first focus or the second focus and the subject, a number of the imaging angles, a rotational angle range by the rotation mechanism, a number of foci on the target, and a number of relative focal positions including the second relative focal position existing between the first relative focal position and the second relative focal position.

5. The X-ray imaging apparatus according to claim 4, wherein the control unit is configured to make the first relative focal position, the second relative focal position, the third relative focal position, and the fourth relative focal position different from each other so as not to overlap, based on the following formula (1):
$$\begin{matrix}[ Formula 3 ] & \\ p = d tan ( \frac{π m Θ}{180 NV} ) s . t . mod ( m , N ) \neq 0 & ( 1 )\end{matrix}$$
where p is the inter-focal distance, d is the focus-to-subject distance, v is the number of the imaging angles, θ is the rotational angle range by the rotation mechanism, N is the number of foci on the target, and m is the number of relative focal positions including the second relative focal position existing between the first relative focal position and the second relative focal position.

6. The X-ray imaging apparatus according to claim 1,
wherein the X-ray tube includes the target, and at least the first electron irradiation unit and the second electron irradiation unit for irradiating electrons to different focal positions on the target, respectively, and
the detector is configured to simultaneously detect X-rays based on the electrons irradiated by the first electron irradiation unit and X-rays based on the electrons irradiated by the second electron irradiation unit.

7. An X-ray tube used in an X-ray imaging apparatus that acquires a plurality of projection image data at a plurality of imaging angles and generates a CT image based on the acquired plurality of the projection image data, the X-ray tube comprising:
at least a first electron irradiation unit and a second electron irradiation unit for simultaneously irradiating electrons to different focal positions of a target,
wherein an inter-focal distance between a first focus of the first electron irradiation unit and a second focus of the second electron irradiation unit, and a number of foci on the target are preset such that a first relative focal position of the first electron irradiation unit with respect to a subject at a first imaging angle, a second relative focal position of the second electron irradiation unit with respect to the subject at the first imaging angle, a third relative focal position of the first electron irradiation unit with respect to the subject at a second imaging angle, and a fourth relative focal position of the second electron irradiation unit with respect to the subject at the second imaging angle are different from each other without overlapping.
